(19) United States
(12) Patent Application Publication
(10) Pub. No.: US 2017/0103415 A1
(43) Pub. Date: Apr. 13, 2017

(54) SELECTING AUDIENCE MESSAGES FOR AN EVENT BASED ON AUDIENCE ANALYTICS

(71) Applicant: MasterCard International Incorporated, Purchase, NY (US)

(72) Inventors: Debashis Ghosh, Charlotte, NC (US); Randy Shuken, Westport, CT (US); Manash Bhattacharjee, Jersey City, NJ (US)

(21) Appl. No.: 14/881,320

(22) Filed: Oct. 13, 2015

(51) Int. Cl. G06Q 30/02; G06Q 50/16

(52) U.S. Cl. CPC G06Q 30/0252; G06Q 30/0255; G06Q 50/16; G06Q 30/0206; G06Q 30/0278

(57) ABSTRACT

A method for selecting audience messages for an event based on audience analytics. A content management computing device determines a set of geographical regions viewing rights for an event were purchased, and in what quantity based on a first set of transaction data. The content management computing then receives a second set of transaction data associated with a set of consumers and generates one or more microsegment data sets based on the second set of transaction data. The microsegments are subdivided based on at least the set of geographical regions. The content management computing device then generates an audience profile based on the microsegment data sets. The content management computing device then receives a plurality of audience messages for the event, and selects one or more audience messages from the plurality of audience messages based on the audience profile.

### BACKGROUND

This disclosure relates to selecting audience messages for display at an event from a plurality of audience messages, and more specifically using transaction data related to purchases of viewing rights for the event, and transaction data on a set of consumers to select which audience messages will be displayed at the event.

Businesses, working through advertising firms, purchase advertising time and/or space from selling entities hosting an event for which there is an audience. The audience can be physically at the event, or accessing the event remotely. Video, text and audio content are often displayed to convey messages to an audience. In some cases, these audience messages may relate to a product or service being sold. These “audience messages” may be considered advertisements for such products or services. Such audience messages are displayed to audiences in order to generate a return on an investment made to purchase the space or time in which the audience message is displayed. Businesses are interested in purchasing time or space for their audience messages that will provide the greatest return on their investment.

Many selling entities from which audience message space or time is purchased (e.g., TV stations, radio stations, those who own outdoor advertisement space, sports stadiums, etc.) also work through similar advertising firms. These firms often negotiate on behalf of their respective clients to agree upon a “pay for performance”-style contract, in which the business pays for a certain number of views of the audience message content by audience members. Audience composition can vary based on a number of factors, from the location of the event if the event is physically attended, to the nature of the event itself. In an effort to help businesses generate the greatest return on their investment, as well as aiding in determining a value for one particular time or space for displaying an audience message versus another particular time or space for displaying said audience message, a method for determining which audience messages should be displayed at which event is needed.

### BRIEF DESCRIPTION OF THE DISCLOSURE

In one aspect, a method for selecting audience messages for an event based on audience analytics is provided. The method is implemented by a computing device coupled to a memory device. The method includes determining a set of geographic regions where viewing rights for an event were purchased, and a quantity in which the viewing rights were purchased in the respective geographic regions based on a first set of transaction data. The method additionally includes receiving a second set of transaction data from a financial transaction processing agency associated with a set of consumers, and generating one or more microsegment data sets based on the second set of transaction data wherein the microsegment data is subdivided based on at least the set of geographic regions in which viewing rights were purchased. The method additionally includes generating an audience profile for the event based on the microsegment data sets corresponding to the event wherein the audience profile includes one or more commonly purchased items within the microsegment data sets, receiving a plurality of audience messages for the event, and selecting one or more audience messages for the event from the plurality of audience messages based on the audience profile.

In another aspect, a system for selecting audience messages for an event based on audience analytics is provided. The system includes a content management computing device including a processor in communication with a memory. The content management computing device is configured to determine a set of geographic regions where viewing rights for an event were purchased and a quantity in which the viewing rights were purchased in the respective geographic regions based on a first set of transaction data. The system receives a second set of transaction data from a financial transaction processing agency associated with a set of consumers, and generates one or more microsegment data sets based on the second set of transaction data wherein the microsegment data is subdivided based on at least the set of geographic regions in which viewing rights were purchased. The system additionally generates an audience profile for the event based on the microsegment data sets corresponding to the event, wherein the audience profile includes one or more commonly purchased items within the microsegment data sets, and receives a plurality of audience messages for the event and selects one or more audience messages for the event from the plurality of audience messages based on the audience profile.

In yet another aspect, a computer-readable storage media for selecting audience messages for an event based on audience analytics is provided. The computer-readable storage media has computer-executable instructions embodied on it. When executed by at least one processor, the computer-executable instructions cause the processor to determine a set of geographic regions where viewing rights for an event were purchased and a quantity in which the viewing rights were purchased in the respective geographic regions based on a first set of transaction data. The computer-executable instructions additionally cause the processor to receive a second set of transaction data from a financial transaction processing agency associated with a set of consumers, and further cause the processor to generate one or more microsegment data sets based on the second set of transaction data wherein the microsegment data is subdivided based on at least the set of geographic regions in which viewing rights were purchased. The computer-executable instructions further cause the processor to generate an audience profile for the event based on the microsegment data sets corresponding to the event, wherein the audience profile includes one or more commonly purchased items within the microsegment data sets, receive a plurality of audience messages for the event, and select one or more audience messages for the event from the plurality of audience messages based on the audience profile.

### BRIEF DESCRIPTION OF THE FIGURES

FIGS. 1-9 show example embodiments of the methods and systems described herein.

FIG. 1 is a schematic diagram illustrating an enhanced multi-party industry system for enabling payment-by-card transactions in communication with a content management computing device.

FIG. 2 is a simplified block diagram of an example payment processing system including a payment processing server computing device, a content management computing device, and a plurality of computing devices in accordance with one example embodiment of the present disclosure.

FIG. 3 is an expanded block diagram of a server architecture of the payment processing system including the plurality of computing devices and a content management computing device in accordance with one example embodiment of the present disclosure.

FIG. 4 illustrates a configuration of a client system shown in FIGS. 2 and 3 in accordance with one example embodiment of the present disclosure.

FIG. 5 illustrates a configuration of a server system shown in FIGS. 2 and 3 in accordance with one example embodiment of the present disclosure.

FIG. 6 is a block diagram illustrating a high-level view of a system architecture of a financial transaction processing system in accordance with exemplary embodiments.

FIG. 7 illustrates a data flow diagram of the method of selecting audience messages utilizing a content management computing device in accordance with one example embodiment of the present disclosure.

FIG. 8 is a flowchart of an example process implemented by the content management computing device for selecting one or more audience messages for an event in one example embodiment of the present disclosure.

FIG. 9 is a diagram of components of one or more example computing devices that may be used in the system shown in FIG. 2.

### DETAILED DESCRIPTION OF THE DISCLOSURE

The systems and methods described herein facilitate selecting audience messages for an event based on audience analytics. The system includes a content management computing device coupled to a memory device. The content management computing device determines a set of geographical regions where viewing rights (e.g., tickets, Pay-Per-View subscriptions) for an event (e.g., sporting event, concert) were purchased and in what quantity the viewing rights were purchased in the respective geographic regions (e.g., zip codes), based on a first set of transaction data. The content management computing device additionally receives a second set of transaction data (i.e., day to day purchases of goods and services) associated with a set of consumers from a financial transaction processing agency (e.g., payment processing network). The content management computing device additionally generates one or more microsegment data sets (i.e., a combined data set of consumer information matched to associated transaction information and subdivided based on one or more criteria). The content management computing device subdivides the microsegment data based on at least the set of geographic regions in which viewing rights were purchased. The content management computing device additionally generates an audience profile for the event based on the microsegment data sets associated with the event. In other words, the audience profile represents characteristics of the consumers going to the event. For example, the audience profile includes one or more items (e.g., soft drinks, beer) commonly purchased by consumers within the microsegment data sets. The content management computing device receives a plurality of audience messages associated with the event Audience messages can vary from the different goods and services displayed, to the nature of the audience messages themselves. Audience messages tailored to the interests of a particular audience are likely to leave a more quality impression on the audience than ones that are not, thereby yielding a greater return on a business's investment. Accordingly, the content management computing device selects at least one audience message for the event based on the audience profile.

In some embodiments, the content management computing device receives only one set of data, including the viewing rights purchase data, corresponding geographical region data, as well as transaction data associated with a set of consumers. In some embodiments, the content management computing device determines a ratio of attendance between the various microsegment data sets subdivided by geographical region associated with the event, and selects one or more audience messages for the event based on the audience profile as well as the ratio of attendance (e.g., determining the percentage of multiple fan bases in the audience and selecting audience messages for the event consistent with the percentage based on the audience profile for the various fan bases).

In some embodiments, the content management computing device receives a set of demographic data associated with the set of consumers. The content management computing device then subdivides the microsegment data based on (1) the set of geographic regions in which viewing rights were purchased and (2) the demographic data associated with the set of consumers.

In some embodiments, a second set of transaction data includes product identifiers associated with products purchased, and the content management computing device determines spending behavior patterns of consumers for those purchased products using the second set of transaction data, by determining commonalities in the transaction data for the purchased product. Commonalties may include transaction location, transaction frequency, and/or transaction time. The content management computing device may select one or more viewable audience messages based on the audience profile and the determined spending behavior patterns.

In some embodiments, the content management computing device receives event data including current ticket price, ticket availability data, ticket purchase data, ticket purchase date data, marketing data including attendance-based revenue data, and event date. The content management computing device determines a ticket purchasing behavior pattern based on the volume of tickets purchased in relation to a length of time between the purchase date and the event date. The content management computing device then determines a fluctuating ticket price for the event based on the ticket purchasing behavior pattern and the event data.

In certain embodiments, a second set of transaction data includes transactions amounts for goods and services sold at a first piece of commercial real estate associated with the event. The content management computing device receives the event type data associated with the event. The content management computing device further receives a third set of transaction data including transaction amounts for goods and services sold at a second piece of commercial real estate, and a sale price for the second piece of commercial real estate, wherein the second piece of commercial real estate has the same event type as the event as the first piece of commercial real estate. The content management computing device then determines an appraisal amount for the first piece of commercial real estate based on the second and third set of transaction data and the sale price.

The methods and systems described herein may be implemented using computer programming or engineering techniques including computer software, firmware, hardware or any combination or subset thereof, wherein the technical effect is achieved by performing at least one of: (a) determining, by a content management computing device, a set of geographic regions where viewing rights were purchased, and viewing right purchase quantity associated with the geographic regions based on a first set of transaction data; (b) receiving, by the content management computing device, a second set of transaction data associated with a set of consumers; (c) generating, by the content management computing device, one or more microsegment data sets, wherein a microsegment is based on the second set of transaction data associated with the set of consumers, wherein the microsegment data is subdivided based on at least the set of geographic regions; (d) generating, by the content management computing device, an audience profile for the event based on the microsegment data sets corresponding to the event; (e) receiving, by the content management computing device, a plurality of audience messages for the event; and (f) selecting, by the content management computing device, one or more audience messages for the event from the plurality of audience messages based on the audience profile. The technical effects described herein apply to the technical field of processing electronic signals transmitted through a computer network.

The systems and methods described herein provide the technical advantage of selecting audience messages for a particular event for a particular audience based on commonalities found in sets of customers who reside in the same geographic regions in which viewing rights for the event were purchased. More specifically, the systems and methods described herein enable the content management computing device to determine a set of geographic regions where viewing rights for an event were purchased. The content management computing device then generates microsegment data sets subdivided by geographic region based on transaction data from a set of consumers. The content management computing device develops an audience profile for the event based on microsegment data sets and selects audience messages for the event based on the audience profile. More specifically, the content management computing device provides the technical advantage of reducing the data transmission load of an electronic data network through which audience messages such as advertisements are transmitted. By selecting messages that are likely to be received by the most receptive audiences, an advertisement firm or other party who wishes to disseminate messages can selectively transmit the messages to focused groups of recipients rather than transmitting the messages in a broader, less focused manner. Accordingly, the data transmission load on the network is reduced and the network is able to operate more efficiently.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, smartphones, personal digital assistants (PDAs), key fobs, and/or computers. Each type of transaction card can be used as a method of payment for performing a transaction.

In one embodiment, a computer program is provided, and the program is embodied on a computer-readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

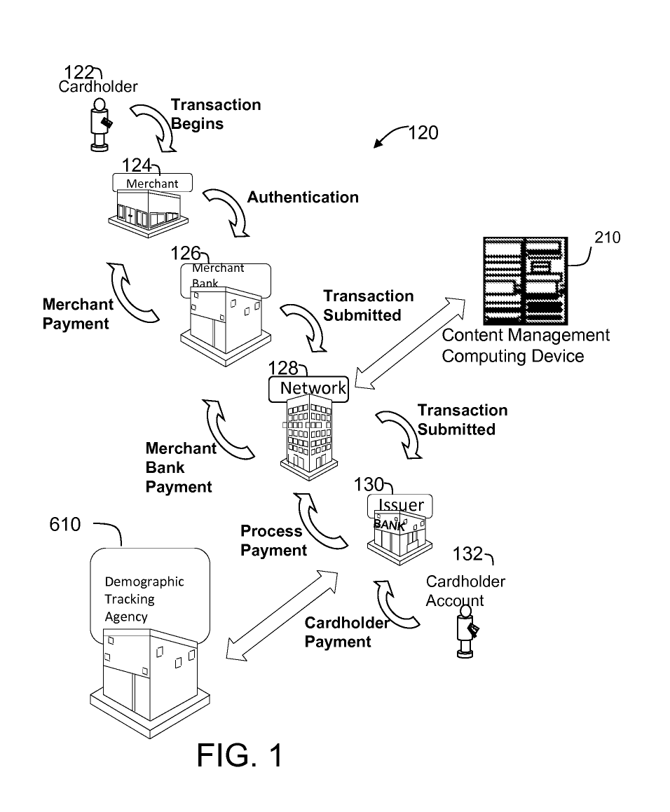

FIG. 1 is a schematic diagram illustrating an enhanced multi-party payment card system 120 for enabling payment-by-card transactions in which merchants and card issuers do not necessarily have a one-to-one relationship. The present disclosure relates to payment card system 120, such as a credit card payment system using the MasterCard® payment card system payment network 128 (also referred to as an “interchange” or “interchange network”). MasterCard® payment card system payment network 128 is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In payment card system 120, a financial institution such as an issuer 130 issues a payment account card, such as a credit card account or a debit card account, to a cardholder 122, who uses the payment account card to tender payment for a purchase from a merchant 124. To accept payment with the payment account card, merchant 124 must normally establish an account with a financial institution that is part of the financial payment system. This financial institution is usually called the “merchant bank” or the “acquiring bank” or “acquirer bank” or simply “acquirer”. When a cardholder 122 tenders payment for a purchase with a payment account card (also known as a financial transaction card), merchant 124 requests authorization from acquirer 126 for the amount of the purchase. The request may be performed over the telephone, but is usually performed through the use of a point-of-interaction terminal, which reads the cardholder's account information from the magnetic stripe on the payment account card or EMV chip and communicates electronically with the transaction processing computers of acquirer 126. Alternatively, acquirer 126 may authorize a third party to perform transaction processing on its behalf. In this case, the point-of-interaction terminal will be configured to communicate with the third party. Such a third party is usually called a “merchant processor” or an “acquiring processor.” In some instances, a merchant (e.g., merchant 124) stores payment card information associated with a cardholder (e.g., cardholder 122) in the form of a unique identifier and requests authorization from acquirer 126 using the unique identifier rather than reading the cardholder's account information from the payment card itself (i.e., a card-on-file (COF) transaction). In some implementations, the computer systems of the payment network 128 communicate with a content management computing device 210 as described in more detail herein.

Using payment card system payment network 128, the computers of acquirer 126 or the merchant processor will communicate with the computers of issuer 130, to determine whether the cardholder's account 132 is in good standing and whether the purchase is covered by the cardholder's available credit line or account balance. In some implementations the unique identifier is used to determine whether the cardholder's account 132 is in good standing. Based on these determinations, the request for authorization will be declined or accepted. If the request is accepted, an authorization code is issued to merchant 124. In some implementations the issuer 130 reports the transaction to demographic tracking agency 610 (e.g. credit bureau) along with the unique identifier associated with the cardholder's account 132 as described in more detail herein.

When a request for authorization is accepted, the available credit line or available balance of cardholder's account 132 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, merchant 124 captures the transaction by, for example, appropriate data entry procedures on the point-of-interaction terminal. If a cardholder cancels a transaction before it is captured, a “void” is generated. If a cardholder returns goods after the transaction has been captured, a “credit” is generated.

For PIN debit card transactions, when a request for authorization is approved by the issuer, the cardholder's account 132 is decreased. Normally, a charge is posted immediately to cardholder's account 132. The bankcard association then transmits the approval to the acquiring processor for distribution of goods/services, or information or cash in the case of an ATM.

After a transaction is captured, the transaction is cleared and settled between merchant 124, acquirer 126, and issuer 130. Clearing refers to the communication of financial data for reconciliation purposes between the parties. Settlement refers to the transfer of funds between the merchant's account, acquirer 126, and issuer 130 related to the transaction.

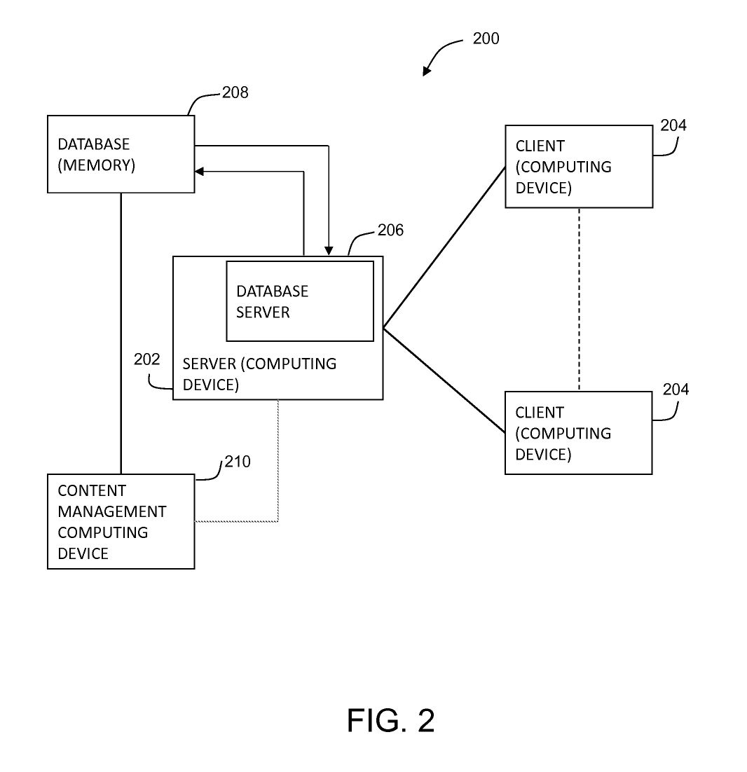

FIG. 2 is a simplified block diagram of an example payment processing system 200 in accordance with one embodiment of the present disclosure. In the example embodiment, system 200 includes a payment processing server computing device 202, a plurality of client subsystems, also referred to as client systems 204 or client computing devices, connected to payment processing server computing device 202, and a content management computing device 210. In one embodiment, client systems 204 are computers including a web browser, such that payment processing server computing device 202 is accessible to client systems 204 using the Internet. Client systems 204 are interconnected to the Internet through many interfaces including a network, such as a local area network (LAN) and/or a wide area network (WAN), dial-in connections, cable modems, wireless-connections, and special high-speed ISDN lines. Client systems 204 may be any device capable of interconnecting to the Internet including a mobile computing device, such as a notebook computer, a web-based phone, a personal digital assistant (PDA), or other web-connectable equipment. In one embodiment, client computing device 204 includes a point-of-sale (POS) device, a cardholder computing device (e.g., a smartphone, a tablet, or other computing device), or any other computing device capable of communicating with payment processing server computing device 202. A database server 206 is connected to database 208 containing information on a variety of matters, as described below in greater detail. In one embodiment database 208 is stored on payment processing server computing device 202 and may be accessed by potential users at one of client systems 204 by logging onto payment processing server computing device 202 through one of client systems 204. In any alternative embodiment, database 208 is stored remotely from payment processing server computing device 202 and may be non-centralized.

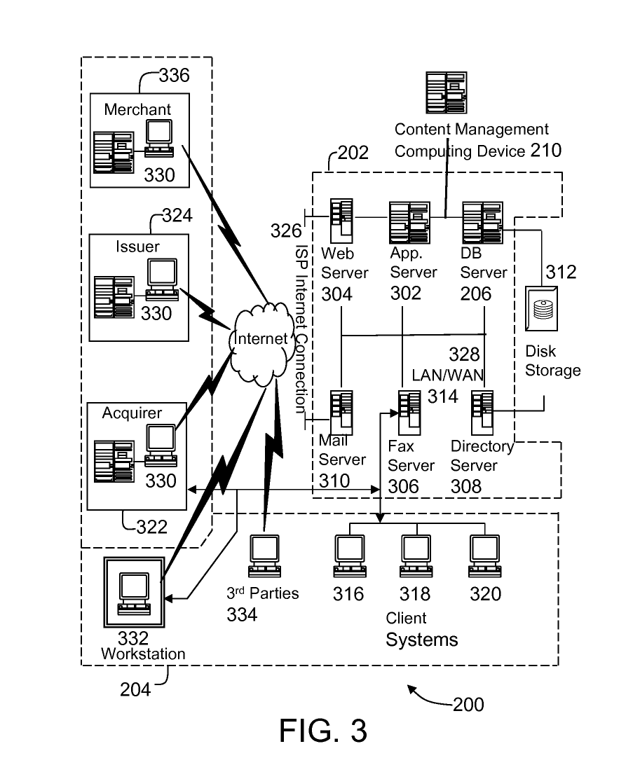

FIG. 3 is an expanded block diagram of an example embodiment of a server architecture of payment processing system 200 in accordance with one embodiment of the present disclosure. Payment processing system 200 includes payment processing server computing device 202, client systems 204, and content management computing device 210. Payment processing server computing device 202 includes database server 206, an application server 302, a web server 304, a fax server 306, a directory server 308, and a mail server 310. A disk storage unit 312 is coupled to database server 206 and directory server 308. Servers 206, 302, 304, 306, 308, and 310 are coupled in a local area network (LAN) 314. In addition, a system administrator's workstation 316, a user workstation 318, and a supervisor's workstation 320 are coupled to LAN 314. Alternatively, workstations 316, 318, and 320 are coupled to LAN 314 using an Internet link or are connected through an Intranet. In some implementations, content management computing device 210 is remote from payment processing server computing device 202 but communicatively coupled thereto. In other implementations, content management computing device 210 is incorporated into payment processing server computing device 202.

Each workstation, 316, 318, and 320, is a personal computer having a web browser. Although the functions performed at the workstations typically are illustrated as being performed at respective workstations 316, 318, and 320, such functions can be performed at one of many personal computers coupled to LAN 314. Workstations 316, 318, and 320 are illustrated as being associated with separate functions only to facilitate an understanding of the different types of functions that can be performed by individuals having access to LAN 314.

Payment processing server computing device 202 is configured to be communicatively coupled to various entities, including acquirers 322 and issuers 324, and to third parties 334 (e.g., auditors) using an Internet connection 326. Server system 202 is also communicatively coupled with one or more merchants 336. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 328, local area network 314 could be used in place of WAN 328. As described above, in some implementations, content management computing device 210 is remote from payment processing server computing device 202 but communicatively coupled thereto. In other implementations, content management computing device 210 is incorporated into payment processing server computing device 202.

In the example embodiment, any authorized individual or entity having a workstation 330 may access system 200. At least one of the client systems includes a manager workstation 332 located at a remote location. Workstations 330 and 332 include personal computers having a web browser. Furthermore, fax server 306 communicates with remotely located client systems, including a client system 332, using a telephone link. Fax server 306 is configured to communicate with other client systems 316, 318, and 320 as well.

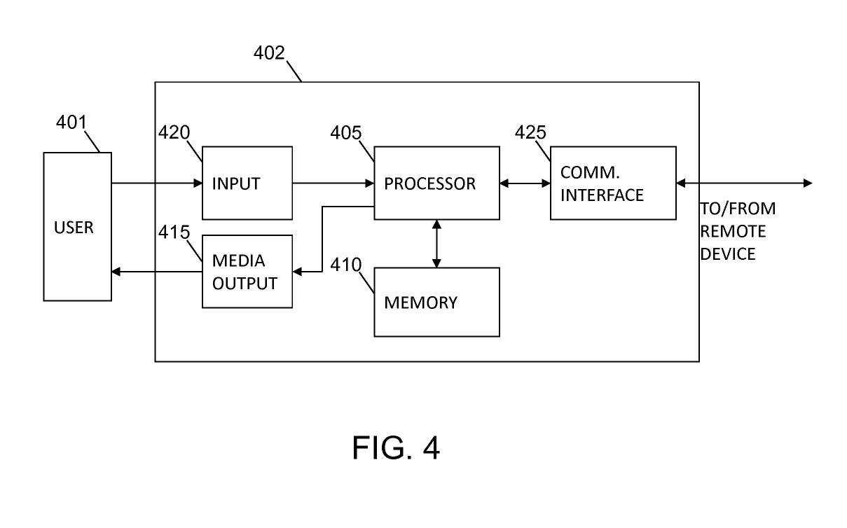

FIG. 4 illustrates an example configuration of a client computing device 402. Client computing device 402 may include, but is not limited to, client systems (“client computing devices”) 204, 316, 318, and 320, workstation 330, manager workstation 332, and third party computing devices 334 (shown in FIG. 3).

Client computing device 402 includes a processor 405 for executing instructions. In some embodiments, executable instructions are stored in a memory area 410. Processor 405 may include one or more processing units (e.g., in a multi-core configuration). Memory area 410 is any device allowing information such as executable instructions and/or other data to be stored and retrieved. Memory area 410 may include one or more computer-readable media.

Client computing device 402 also includes at least one media output component 415 for presenting information to a user 401. Media output component 415 is any component capable of conveying information to user 401. In some embodiments, media output component 415 includes an output adapter such as a video adapter and/or an audio adapter. An output adapter is operatively coupled to processor 405 and operatively coupleable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 420 for receiving input from user 401. Input device 420 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 415 and input device 420.

Client computing device 402 may also include a communication interface 425, which is communicatively coupleable to a remote device such as server system 202 or a web server operated by a merchant. Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 410 are, for example, computer-readable instructions for providing a user interface to user 401 via media output component 415 and, optionally, receiving and processing input from input device 420. A user interface may include, among other possibilities, a web browser and client application. Web browsers enable users 401 to display and interact with media and other information typically embedded on a web page or a website from a web server associated with a merchant. A client application allows users 401 to interact with a server application associated with, for example, a merchant.

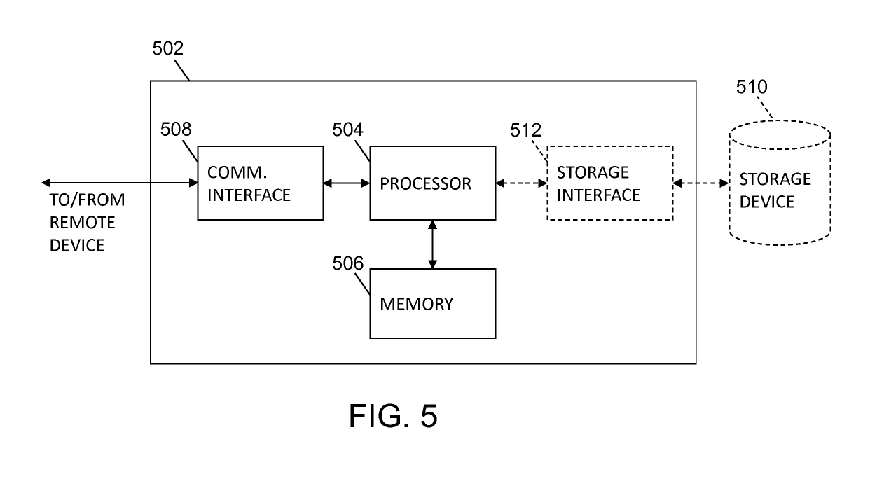

FIG. 5 illustrates an example configuration of a server computing device 502. Server computing device 502 is representative of payment processing server computing device 202 (shown in FIGS. 2 and 3), database server 206, application server 302, web server 304, fax server 306, directory server 308, mail server 310, and one or more computing devices included in content management computing device 210.

Server computing device 502 includes a processor 504 for executing instructions. Instructions may be stored in a memory area 506, for example. Processor 504 may include one or more processing units (e.g., in a multi-core configuration).

Processor 504 is operatively coupled to a communication interface 508 such that server computing device 502 is capable of communicating with a remote device such as client computing device 402 or another server computing device 502. For example, communication interface 508 may receive requests from client systems 204 via the Internet, as illustrated in FIGS. 2 and 3.

Processor 504 may also be operatively coupled to a storage device 510. Storage device 510 is any computer-operated hardware suitable for storing and/or retrieving data. In some embodiments, storage device 510 is integrated in server computing device 502. For example, server computing device 502 may include one or more hard disk drives as storage device 510. In other embodiments, storage device 510 is external to server computing device 502 and may be accessed by a plurality of server computing devices 502. For example, storage device 510 may include multiple storage units such as hard disks or solid state disks in a redundant array of inexpensive disks (RAID) configuration. Storage device 510 may include a storage area network (SAN) and/or a network attached storage (NAS) system.

In some embodiments, processor 504 is operatively coupled to storage device 510 via a storage interface 512. Storage interface 512 is any component capable of providing processor 504 with access to storage device 510. Storage interface 512 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 504 with access to storage device 510.

Memory areas 410 and 506 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

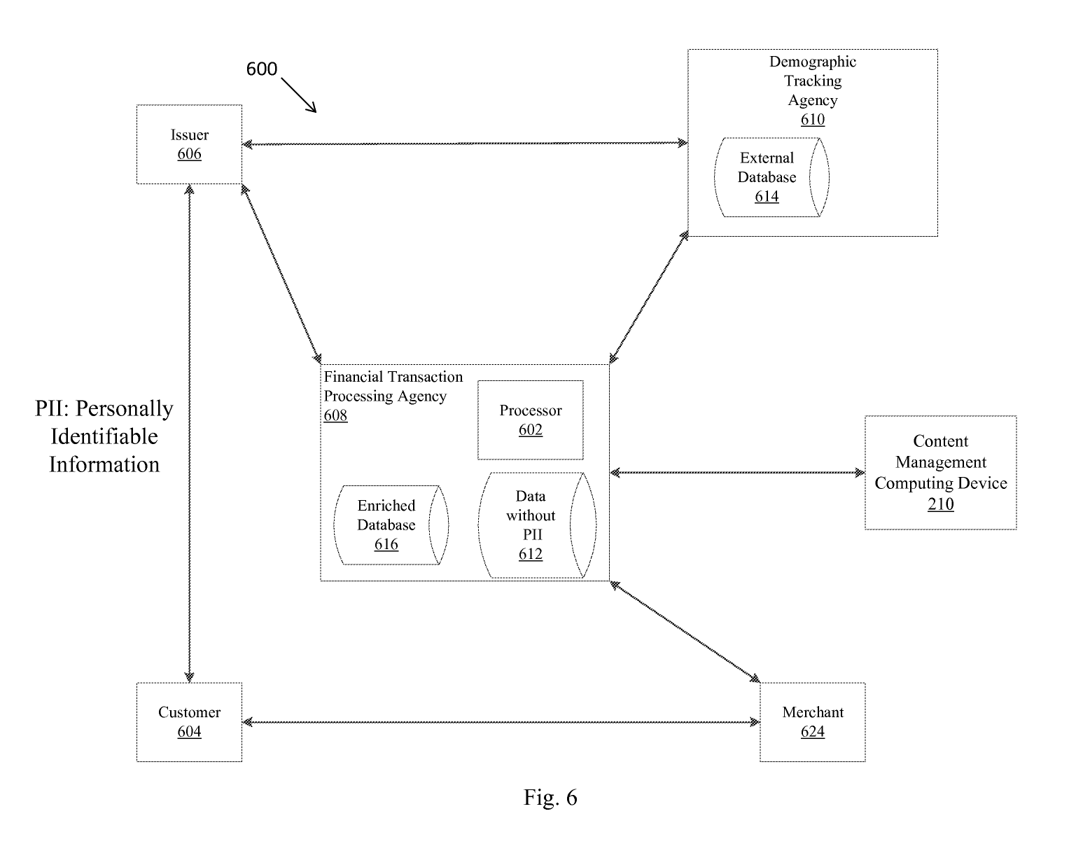

FIG. 6 illustrates a financial transaction processing system 600 including a customer 604, a merchant 624, an issuer 606, a financial transaction processing agency 608, a demographic tracking agency 610 and a content management computing device 210. In some embodiments, the customer 604 is the cardholder 122 (shown in FIG. 1). In some embodiments, the merchant 624 is the merchant 124 (also shown in FIG. 1).

The customer 604 uses a payment card at the merchant 624 for payment of a financial transaction. The payment card may be any type of transaction card used for making payments in a financial transaction, such as a debit card, credit card, charge card, ATM card, etc. Each payment card is assigned a unique identifier that links the payment card to a customer (e.g., customer 604).

Merchant 624 forwards the payment card information (e.g., the unique identifier) as well as transaction information (e.g., the amount, merchant information, time and date information, etc.) to the financial transaction processing agency 608 for processing. The financial transaction processing agency 608 may be any service provider for merchants, acquirers, issuers, consumers, etc. for the processing of transactions involving payment cards, such as MasterCard or VISA® (VISA is a registered trademark of Visa International Service Association, Foster City, Calif.). The financial transaction processing agency 608 may issue an authorization request from the issuer 606. The issuer 606 may be an entity (e.g., a bank or the merchant 624) that issued the payment card used in the transaction, a stand-in processor configured to act on behalf of the issuer of the payment card, a credit bureau that has card- or consumer-related information, or any other suitable entity. In some implementations, the financial transaction processing agency 608 is the payment network 128 (shown in FIG. 1).

The issuer 606 approves or denies the transaction. If the issuer 606 approves the transaction, the issuer 606 notifies the financial transaction processing agency 608 of the approval. The financial transaction processing agency 608 then notifies the merchant 624 of the approval of the transaction, who then finalizes the transaction with the customer 604. The issuer 606 then bills the customer 604 for payment of the transaction and reports any payments, or lack thereof, to the demographic tracking agency 610 (e.g., a credit report agency, a marketing and research firm such as The Nielsen Company, etc.). The demographic tracking agency 610, therefore, may possess personally identifiable information (PII) of the customer 604 including the customer's unique identifier, which may be stored in the external database 614, though the financial transaction processing agency 608 would not be in possession of the PII or have access to it.

### Personally Identifiable Information

Personally identifiable information (PII) may be information that may be used, alone or in conjunction with other sources, to uniquely identify a single individual (e.g., the customer 604). As such, there is a benefit to prevent the use and dissemination of PII in an effort to protect consumer privacy and to prevent against crimes, such as identity theft. The present disclosure provides for methods where the financial transaction processing agency 608 (e.g., MasterCard) does not possess any data containing personally identifiable information in processes that help accurately identify groups of individuals or businesses having particular interests or desires across a broad and diverse population of cardholders.

This is done, viewed at a high level, by enriched data associated with individuals or businesses (entities), to include transaction history and demographics, but not PII, as associated by a unique identifier, and placing like entities, filtered by criteria, into groups. Therefore, third parties (e.g., advertisers) that have contact information for entities can group them and match them to the enriched data groups. Whether or not the groups from the combined/enriched data sets and from the data sets have parity, common members, or no overlap, statistically the matched groups have predictable behavior, particularly in small groups or microsegments (as defined below). Having grouped the third party's data set members into small groups based on selected activities and/or characteristics (e.g., demographic and geographic information), the third party can effectively direct communications of interest to these small groups or microsegments. The third party may possess contact information, which may include PII, such as e-mail addresses, phone numbers, etc. In an exemplary embodiment, the contact information that may include PII may be removed from the third party data set or made otherwise unavailable to the financial transaction processing agency 608.

In some embodiments, bucketing may be used in order to render potentially identifiable information anonymous, such as by aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the financial transaction processing agency 608 may not possess the PII or be able to decrypt the encrypted PII.

Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc.

### Protection of PII in a Financial Transaction Processing System

As illustrated in FIG. 6, the financial transaction processing agency 608 in some implementations includes a database without PII 612 and an enriched database 616, which also does not include PII. The demographic tracking agency 610 may include the external database 614, which may include PII not accessible by the financial transaction processing agency 608.

The database without PII 612 may store information on a plurality of consumers (e.g., the customer 604) that is not personally identifiable including each customer's 604 unique identifier. For example, the financial transaction processing agency 608 may store information relating to financial transactions processed by the agency as it performs in the system 600, such as transaction amount, transaction time, transaction location, merchant identification, etc. and do so without the use of any PII relating to the customer 604 participating in the transactions.

The financial transaction processing agency 608 may communicate with the demographic tracking agency 610 via a network described below. The financial transaction processing agency 608 may obtain non-personally identifiable information from the external database 614. Non-personally identifiable information included in the external database 614 may include geographical data, demographic data, financial data, or any other suitable data as will be apparent to persons having skill in the relevant art, hereinafter referred to generally as demographic data. In one embodiment, the information included in the external database 614 may be bucketed and thus not personally identifiable. The financial transaction processing agency 608 may combine the non-personally identifiable information provided by the demographic tracking agency 610 with information included in the database without PII 612 into a single data set using each customer's unique identifier. The combined data set may be stored in the enriched database 616. In some embodiments, the financial transaction processing agency 608 may aggregate (e.g., bucket, group, etc.) data in each of the external database 614 and the database without PII 612 prior to combining the information into a single data set.

Each of the databases 612, 614, and 616 may be any type of database suitable for the storage of data as disclosed herein. Each database may store data in a single database, or may store data across multiple databases and accessed through a network. Network configurations as disclosed herein may include a local area network (LAN), a wide area network (WAN), a wireless network (e.g., WiFi), a mobile communication network, a satellite network, the Internet, fiber optic, coaxial cable, infrared, radio frequency (RF) or any other suitable configuration as would be apparent to persons having skill in the relevant art.

Data may be stored on any type of suitable computer readable media, such as optical storage (e.g., a compact disc, digital versatile disc, blu-ray disc® [Blu-Ray Disc is a registered trademark of Blu-Ray Disc Association Nonprofit Mutual Benefit Corporation, Burbank, Calif.], etc.) or magnetic tape storage (e.g., a hard disk drive). The database may be configured in any type of suitable database configuration, such as a relational database, a structured query language (SQL) database, a distributed database, an object database, etc. Suitable configurations and database storage types will be apparent to persons having skill in the relevant art.

The database without PII 612 and the enriched database 616 may be included as part of the financial transaction processing agency 608 internally or externally and accessed through a network. The database without PII and the enriched database may be included as part of database 208 or content management computing device 210. The external database 614 may be included as part of the demographic tracking agency 610 internally or externally and accessed through a network. Each database may be a single database, or may comprise multiple databases which may be interfaced together. In some embodiments, the database without PII 612 and the enriched database 616 may be a single database.

The financial transaction processing agency 608 may include a processor 602, which may be any type of processing device capable of performing the functions as disclosed herein, such as a general purpose computer, a general purpose computer configured as disclosed herein to become a specific purpose computer, etc. The processing device may be a single system (e.g., a single specific purpose computer) or may be comprised of several interconnected (e.g., physically or through a network) systems or servers (e.g., a server farm). The processor 602 may be coupled to each of the databases 612, 614, and 616 either physically (e.g., through a cable such as a coaxial cable, fiber-optic cable, etc.) or through a network (e.g., the network 128).

The processor 602 may be configured to receive information from both the database without PII 612 and to receive information with the PII removed from the external database 614, and to combine the data to form a combined data set without PII. In some embodiments, the processor 602 may aggregate the information received from at least one of the two databases prior to combining the information into the combined data set. The processor 602 may also be configured to store the combined data set (e.g., that does not include PII) in the enriched database 616. The processor 602 may be further configured to review the combined data set or to select microsegments based on the combined data set. In some embodiments processor 602 is contained within content management computing device 210. In some embodiments enriched database 616 is contained within content management computing device 210.

Information that is stored in the database without PII 612 may be retrieved (e.g., by the processor 602). In one embodiment, all of the information stored in the database without PII 612 may be retrieved. In another embodiment, only a single entry in the database without PII 612 may be retrieved. The retrieval of information may be performed a single time, or may be performed multiple times. In an exemplary embodiment, only information pertaining to a specific microsegment (discussed further below) may be retrieved from the database without PII 612. The retrieved information may be associated with an entity (e.g., a cardholder, a business, a microsegment, any group or combination thereof, etc.) by the processor 602.

The processor 602 may retrieve information (e.g., that does not include any personally identifiable information) from the external database 614. The retrieval performed may be of the same type and retrieve the corresponding information (e.g., relating to the same microsegment) as the information retrieved from the database without PII 612. In one embodiment, if the external database 614 includes PII, the financial transaction processing agency 608 may be prohibited from accessing the PII. The information retrieved in this step may then be associated with an entity. The enriched database 616 may store the information obtained and associated in the prior steps, the information not containing any PII. As a result, the financial transaction processing agency 608 may not be in contact with or have access to any PII during the process. In some, embodiments it may be the content management computing device 210 which is prohibited from accessing the PII.

Microsegments may be subdivided by content management computing device 210 based on the information that was obtained and stored in the enriched database 616. The selection of information for representation in the microsegment or microsegments may be different in every instance. In one embodiment, all of the information stored in the enriched database 616 may be used for selecting microsegments. In an alternative embodiment, only a portion of the information, such as geographic region, may be used. The selection of microsegments may be based on specific criteria (e.g., from a research firm or advertising agency).

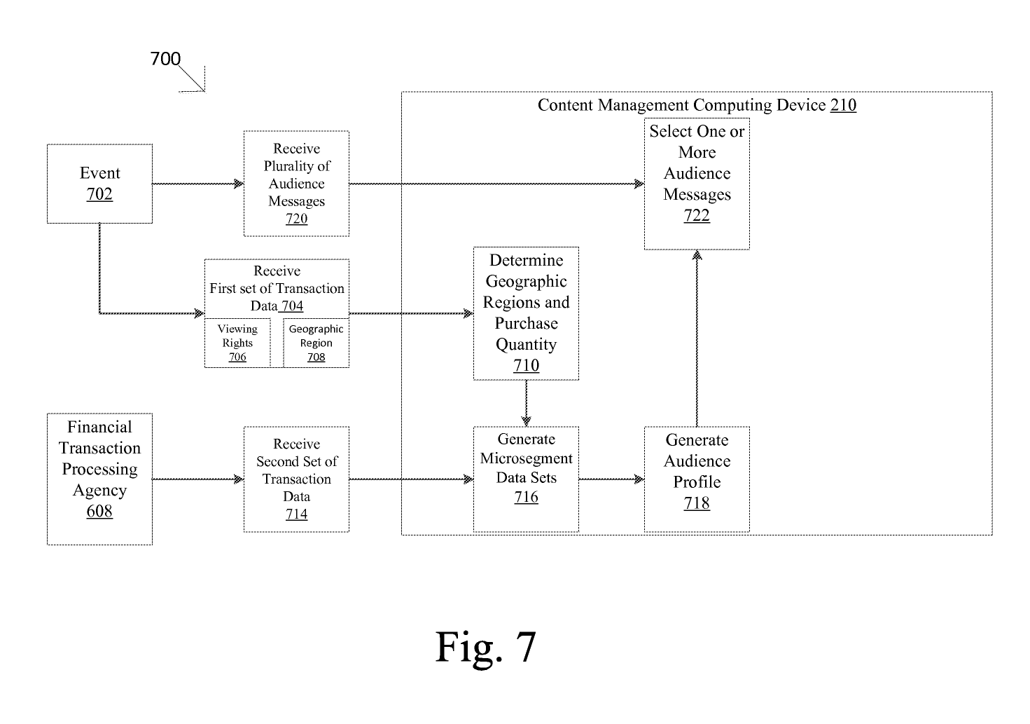

FIG. 7 is a data flow diagram 700 for a first and second set of transaction data and a plurality of audience messages processed and stored by the content management computing device 210 (shown in FIG. 2). Content management computing device 210 receives a first set of transaction data 704 which includes transaction data of viewing rights 706 purchased for an event 702, and a geographic location 708 where the viewing rights 706 were purchased. Content management computing device 210 uses the first set of transaction data 704 to determine a set of geographic regions where viewing rights were purchased and in what quantity the viewing rights were purchased in their corresponding geographic region 710. Content management computing device 210 receives a second set of transaction data 714 associated with a set of consumers 604 from financial transaction processing agency 608 and enriched database 616 (all shown in FIG. 6). Content management computing device 210 generates microsegment data sets 716 that are based on the second set of transaction data and subdivided based on the determined set of geographic regions 710 where viewing rights 706 were purchased. From the microsegment data sets, content management computing device 210 generates an audience profile 718 of event 702. Content management computing device 210 generates the audience profile 718 based on common purchase items found in the one or microsegment data sets.

Content management computing device 210 receives a plurality of audience messages 720. The plurality of audiences messages received may include any or all of the audience messages that are available to be shown to the particular audience at the event (i.e., the audience represented by the audience profile). As described above, the audience messages may be part or all of an available inventory of audience messages, or the content for which time or space have been purchased (e.g., by a purchasing entity such as a brand or advertising agency) from a selling entity (e.g., an owner of the location of the event). Content management computing device 210 then selects one or more audience messages 722 based on the audience profile and the common purchase items identified from a plurality of audience messages received 720. For example, if the audience profile generated 718 suggests that the audience for the event prefers soft drinks over beer, or a particular brand of soft drink, audience messages containing references to soft drinks and/or the particular brand of soft drink may be selected by content management computing device 210. If the audience profile generated 718 suggests that the audience for the event includes consumers that prefer soft drinks as well as consumers that prefer beer, at some particular ratio (e.g., 2:1), content management computing device 210 may select audience messages to show at the particular ratio for soft drinks and beet (i.e., a 2:1 ratio of soft drink-related audience messages to beer-related audience messages).

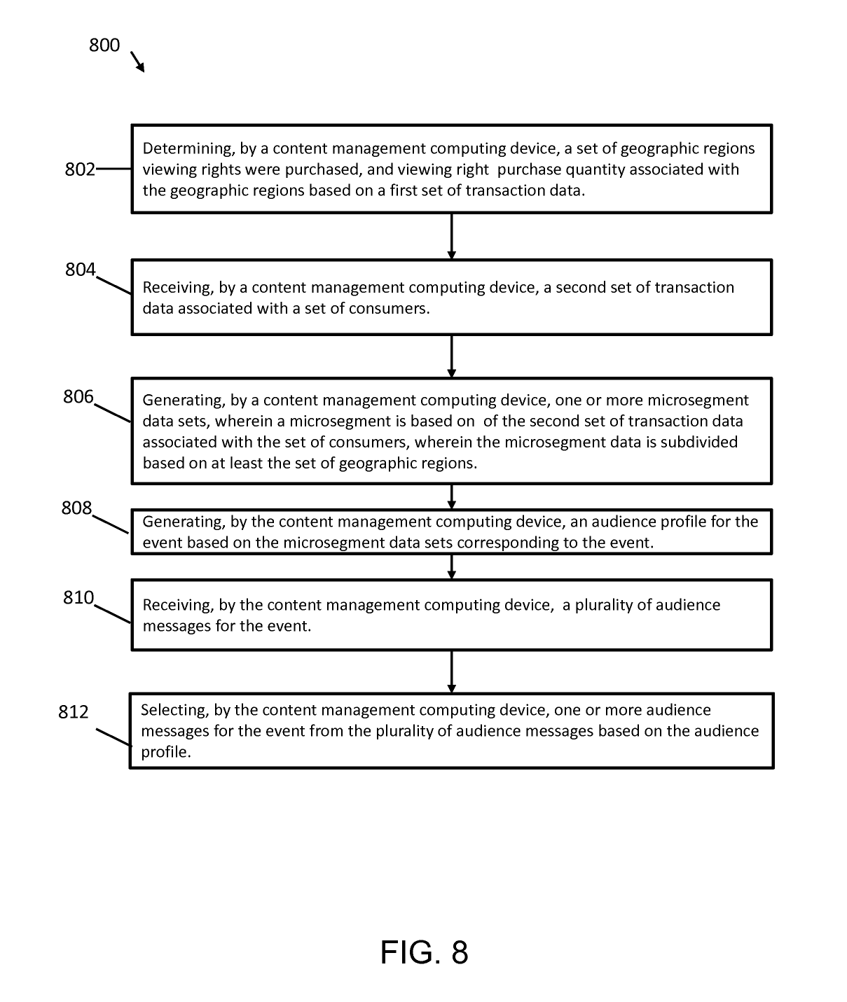

FIG. 8 is a flowchart of an example process 800 implemented by content management computing device 210 for selecting audience messages for an event from a plurality of audience messages based on audience analytics. Content management computing device 210 determines 802 a set of geographic regions where viewing rights were purchased, and viewing right purchase quantity associated with the geographic regions based on a first set of transaction data. Content management computing device 210 receives 804 a second set of transaction data associated with a set of consumers 122 from financial transaction processing agency 608. Content management computing device 210 then generates 806 one or more microsegment data sets, wherein a microsegment is based on the second set of transaction data, wherein the microsegment data is subdivided based on at least the set of geographic regions. Content management computing device 210 generates 808 an audience profile based on common purchase items found in the one or microsegment data sets. Content management computing device 210 receives 810 a plurality of audience messages for the event. Content management computing device 210 selects 812 one or more audience messages for the event from the plurality of audience messages based on the audience profile.

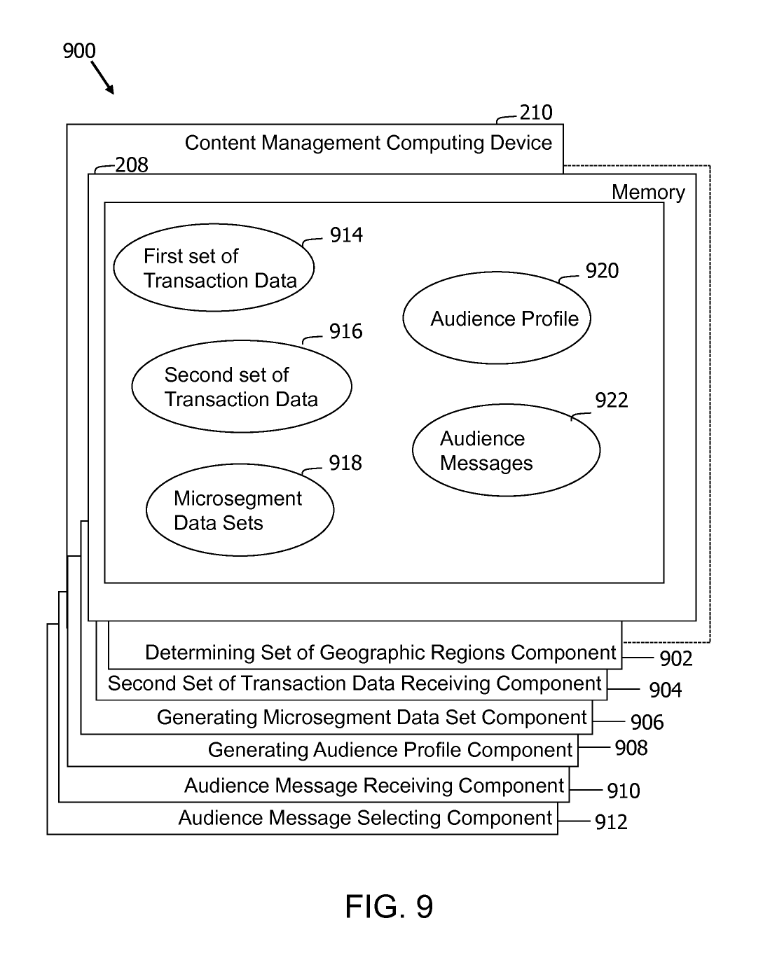

FIG. 9 is a diagram 900 of components of one or more example computing devices, for example content management computing device 210, that may be used in embodiments of the described systems and methods. FIG. 9 further shows a configuration of data in database 208, which in at least some implementations is representative of data from database for data without PII 612, external database 614, and enriched database 616. Database 208 is in communication with several separate components within content management computing device 210, which perform specific tasks.

Content management computing device 210 includes a geographic region set determining component 902 for determining a set of geographic regions based on a first set of transaction data associated with viewing right 706 purchases to event 702. Additionally, content management computing device 210 includes a second set of transaction data component 904 associated with a set of consumers. Further, content management computing device 210 includes microsegment data set generating component 906 which divides the second set of transaction data based on the geographic regions 708 where viewing rights 706 were purchased for event 702. Additionally, content management computing device 210 includes an audience profile generating component 908 based on common purchase items found in one or more microsegment data sets. Content management computing device 210 also includes an audience message receiving component 910 which receives a plurality of audience messages for event 702. Additionally, content management computing device 210 includes an audience message selecting component 912 wherein an audience message is selected from the plurality of audience messages received for event 702 based on the audience profile. In at least some embodiments, audience messages are received from a third party such as, for example, an advertisement management party, or an entity that sells time or space to such advertisement management parties for purchase to show an audience message from an inventory of audience messages.

It should be understood that content management computing device 210 may have additional or fewer components. For example, content management computing device 210 may have a comparison component (not shown). The comparison component may be configured to use received transaction data for a first piece of commercial real estate (e.g., transaction data received by receiving component 904) as well as received transaction data for a second, similar piece of commercial real estate, and a sale price or value of the second piece of commercial real estate, to estimate or generate a value for the first piece of commercial real estate. The comparison component may use the sale price of the second piece of commercial real estate, as well a comparison of the transaction data of the first piece of real estate with the transaction data of the second piece of real estate, to generate a sale price or value for the first piece of real estate. For example, the second piece of commercial real estate may have been sold or valued at X dollars, and had transaction data indicating a transaction volume of Y dollars the at the second piece of real estate. If the transaction data for the first piece of commercial real estate indicates a transaction volume of 0.8Y dollars, content management computing device 210 may generate a sale price or value for the first piece of real estate of 0.8X dollars.

Additionally or alternatively, content management computing device 210 may have a scheduling component (not shown). The scheduling component may be configured to analyze received transaction data (e.g., transaction data received by receiving component 904) to generate event data associated with the event. The event data may include, for example, current ticket price for a ticket to the event ticket availability data (e.g., a number of tickets available, based on a capacity of the event and a number of tickets sold or bought), and/or ticket purchase date(s). The scheduling component may also generate, determine, and/or receive an event date of the event, as well as attendance-based revenue data. Attendance-based revenue data may describe how a number of tickets sold and/or a ticket price of each ticket purchase affects the revenue generated by the event. Accordingly, the scheduling component may generate a schedule of ticket prices for tickets to the event, wherein a ticket price fluctuates (e.g., increases or decreases) as the event date nears. For example, the scheduling component may determine that ticket prices may be decreased by a certain amount each day or each week in order to sell a greater volume of tickets, which will increase overall revenue or may lead to selling out the event (i.e., selling all available tickets). As another example, the scheduling component may determine that tickets for the event are being sold very rapidly at a current price, and may thus determine that an increase in ticket price closer to the event may increase revenues, as the event may be in great demand, and consumers may pay a higher price for tickets as the event nears. The scheduling component may thus generate a schedule with ticket price increases each day or each week as the event date nears.

In an example embodiment, data in database 208 is divided into a plurality of sections, including but not limited to, a first set of transaction data 914, a second set of transaction data 916, microsegment data sets 918, audience profiles 920, and audience messages 922. These sections stored in database 208 are interconnected to retrieve and store information in accordance with the functions and processes described above.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 405, 504, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for selecting audience messages for an event based on audience analytics, the method implemented using a computing device coupled to a memory device, the method comprising:
determining, by the content management computing device, a set of geographic regions where viewing rights were purchased, and viewing right purchase quantity associated with the geographic regions based on a first set of transaction data;
receiving, by the content management computing device, a second set of transaction data associated with a set of consumers;
generating, by the content management computing device, one or more microsegment data sets, wherein a microsegment is based on the second set of transaction data associated with the set of consumers, wherein the microsegment data is subdivided based on at least the set of geographic regions;
generating, by the content management computing device, an audience profile for the event based on the microsegment data sets corresponding to the event;
receiving, by the content management computing device, a plurality of audience messages for the event; and
selecting, by the content management computing device, one or more audience messages for the event from the plurality of audience messages based on the audience profile.

2. The method of claim 1, wherein there is only one set of transaction data.

3. The method of claim 1, wherein selecting one or more audience messages further comprises:
determining a ratio of attendance between the various microsegment data sets; and
selecting one or more audience messages for the event based on at least one of the audience profiles, and the ratio of attendance.

4. The method of claim 1, further comprising:
receiving a set of demographic data associated with the set of consumers; and
subdividing the microsegment data based on at least one of the set of geographic regions in which viewing rights were purchased, and the demographic data associated with the set of consumers.

5. The method of claim 1, wherein the second set of transaction data includes product identifiers associated with products purchased, the method further comprising:
processing the second set of transaction data to determine spending behavior patterns of a purchased product based on commonalities found in the transaction data for the purchased product, wherein the commonalities include transaction location and transaction time, and
wherein selecting one or more viewable audience messages further comprises selecting one or more viewable audience messages for the event, based on at least one of the spending behavior patterns and the audience profile.

6. The method of claim 1, further comprising:
receiving event data associated with the event, the event data including current ticket price, ticket availability data, ticket purchase data, ticket purchase date data, marketing data including attendance-based marketing revenue data, and an event date;
determining a ticket purchasing behavior pattern based on the volume of tickets purchased in relation to a length of time between the purchase date and the event date; and
determining a fluctuating ticket price for the event based on the ticket purchasing behavior pattern and the event data.

7. The method of claim 1, wherein the second set of transaction data includes transaction amounts for goods and services sold at a first piece of commercial real estate associated with the event, the method further comprising:
receiving the event type data associated with the event;
receiving a third set of transaction data, the third set of transaction data including transaction amounts for goods and services sold at a second piece of commercial real estate, and a sale price of the second piece of commercial real estate, wherein the second piece of commercial real estate has the same event type as the event; and
determining an appraisal amount for the first piece of commercial real estate based on the second and third sets of transaction data and the sale price.

8. A system for selecting audience messages for an event based on audience analytics, the system comprising a content management computing device including a processor in communication with a memory, said content management computing device configured to:
determine a set of geographic regions viewing rights were purchased, and viewing right purchase quantity associated with the geographic regions based on a first set of transaction data;
receive a second set of transaction data associated with a set of consumers;
generate one or more microsegment data sets, wherein a microsegment is based on the second set of transaction data associated with the set of consumers, wherein the microsegment data is subdivided based on at least the set of geographic regions;
generate an audience profile for the event based on the microsegment data sets corresponding to the event;
receive a plurality of audience messages for the event; and
select one or more audience messages for the event from the plurality of audience messages based on the audience profile.

9. The system of claim 8, wherein there is only one set of transaction data.

10. The system of claim 8, wherein the system further configured to select one or more audience messages by:
determining a ratio of attendance between the various microsegment data sets; and
selecting one or more audience messages for the event based on at least one of the audience profile, and the ratio of attendance.

11. The system of claim 8, further configured to:
receive a set of demographic data associated with the set of consumers; and
subdivide the microsegment data based on at least one of the set of geographic regions in which viewing rights were purchased, and the demographic data associated with the set of consumers.

12. The system of claim 8, wherein the second set of transaction data includes product identifiers associated with products purchased, the system further configured to:
process the second set of transaction data to determine spending behavior patterns of a purchased product based on commonalities found in the transaction data for the purchased product, wherein the commonalities may include transaction location and transaction time, and
wherein selecting one or more viewable audience messages further comprises selecting one or more viewable audience messages for the event, based on at least one of the spending behavior patterns and the audience profile.

13. The system of claim 8 further configured to:
receive event data associated with the event, the event data including current ticket price, ticket availability data, ticket purchase data, ticket purchase date data, marketing data including attendance-based marketing revenue data, and an event date;
determine a ticket purchasing behavior pattern based on the volume of tickets purchased in relation to a length of time between the purchase date and the event date; and
determine a fluctuating ticket price for the event based on the ticket purchasing behavior pattern and the event data.

14. The system of claim 8, wherein the second set of transaction data includes transaction amounts for goods and services sold at a first piece of commercial real estate associated with the event, the system further configured to:
receive the event type data associated with the event;
receive a third set of transaction data, the third set of transaction data including transaction amounts for goods and services sold at a second piece of commercial real estate, and a sale price of the second piece of commercial real estate, wherein the second piece of commercial real estate has the same event type as the event; and
determine an appraisal amount for the first piece of commercial real estate based on the second and third sets of transaction data and the sale price.

15. A computer-readable storage media for selecting audience messages for an event based on audience analytics, the computer-readable storage media having computer-executable instructions embodied thereon, wherein, when executed by at least one processor, the computer-executable instructions cause the processor to:
determine a set of geographic regions viewing rights were purchased, and viewing right purchase quantity associated with the geographic regions based on a first set of transaction data;
receive a second set of transaction data associated with a set of consumers;
generate one or more microsegment data sets, wherein a microsegment is based on the second set of transaction data associated with the set of consumers, wherein the microsegment data is subdivided based on at least the set of geographic regions;
generate an audience profile for the event based on the microsegment data sets corresponding to the event;
receive a plurality of audience messages for the event; and
select one or more audience messages for the event from the plurality of audience messages based on the audience profile.

16. The computer-readable storage media of claim 15, wherein there is only one set of transaction data.

17. The computer-readable storage media of claim 15, wherein selecting one or more audience messages further comprises:
determining a ratio of attendance between the various microsegment data sets;
selecting one or more audience messages for the event based on at least one of the audience profile, and the ratio of attendance.

18. The computer-readable storage media of claim 15, wherein the computer-executable instructions further cause the processor to:
receive a set of demographic data associated with the set of consumers; and
subdivide the microsegment data based on at least one of the set of geographic regions in which viewing rights were purchased, and the demographic data associated with the set of consumers.

19. The computer-readable storage media of claim 15, wherein the second set of transaction data includes product identifiers associated with products purchased, the computer-readable storage media further cause the processor to:
process the second set of transaction data to determine spending behavior patterns of a purchased product based on commonalities found in the transaction data for the purchased product, wherein the commonalities may include transaction location and transaction time, and
wherein selecting one or more viewable audience messages further comprises selecting one or more viewable audience messages for the event, based on at least one of the spending behavior patterns and the audience profile.

20. The computer-readable storage media of claim 15 wherein the computer-readable storage media further cause the processor to:
receive event data associated with the event, the event data including current ticket price, ticket availability data, ticket purchase data, ticket purchase date data, marketing data including attendance-based marketing revenue data, and an event date;
determine a ticket purchasing behavior pattern based on the volume of tickets purchased in relation to a length of time between the purchase date and the event date; and
determine a fluctuating ticket price for the event based on the ticket purchasing behavior pattern and the event data.

21. The computer-readable storage media of claim 15, wherein the second set of transaction data includes transaction amounts for goods and services sold at a first piece of commercial real estate associated with the event, the computer-readable storage media further causes the processor to:
receive the event type data associated with the event;
receive a third set of transaction data, the third set of transaction data including transaction amounts for goods and services sold at a second piece of commercial real estate, and a sale price of the second piece of commercial real estate, wherein the second piece of commercial real estate has the same event type as the event; and
determine an appraisal amount for the first piece of commercial real estate based on the second and third sets of transaction data and the sale price.
